(19) United States
(12) Patent Application Publication
(10) Pub. No.: US 2010/0172394 A1
(43) Pub. Date: Jul. 8, 2010

(54) METHOD OF AND APPARATUS FOR TRANSMITTING AND RECEIVING SIGNAL AT VARIABLE DATA RATE IN HUMAN BODY COMMUNICATIONS

(75) Inventors: In-Gi Lim, Daejeon-city (KR); Hyung-Il Park, Daejeon-city (KR); Tae-Wook Kang, Daejeon-city (KR); Sung-Weon Kang, Daejeon-city (KR); Jung-Hwan Hwang, Daejeon-city (KR); Chang-Hee Hyoung, Daejeon-city (KR); Kyung-Soo Kim, Daejeon-city (KR); Jung-Bum Kim, Daejeon-city (KR); Duck-Gun Park, Daejeon-city (KR); Sung-Eun Kim, Daejeon-city (KR); Jin-Kyung Kim, Daejeon-city (KR); Park Ki-Hyuk, Daejeon-city (KR)

Correspondence Address: AMPACC Law Group, 3500 188th Street S.W., Suite 103, Lynnwood, WA, 98037, US

(73) Assignee: Electronics and Telecommunications Research Institute, Daejeon (KR)

(21) Appl. No.: 12/602,092

(22) PCT Filed: May 27, 2008
(86) PCT No.: PCT/KR08/02953

§ 371 Date: Nov. 25, 2009

(30) Foreign Application Priority Data
May 28, 2007 (KR) 10-2007-0051531
Sep. 7, 2007 (KR) 10-2007-0091151

(51) Int. Cl. H04B 1/02; H04B 1/06

(52) U.S. Cl. 375/146; 375/149

(57) ABSTRACT

Provided are a method and apparatus for transmitting and receiving a signal at a variable data rate in human body communications. The apparatus includes a header generator, a data generator, a spreader, and a multiplexer. The header generator generates header information including a data rate. The data generator generates transmission data by repeating each data bit to be transmitted 0 to several times according to the data rate. The spreader spreads the transmission data using a spreading code in a desired frequency band. The multiplexer multiplexes the header information and the spread data.

### TECHNICAL FIELD

The present invention relates to a method of and apparatus for transmitting and receiving a signal of variable data rate in human body communications, and more particularly, to a method of and apparatus for transmitting and receiving a signal of variable data rate in a limited frequency band in a communication system whose propagation medium is a human body.

This work was partly supported by the IT R&D program of MIC/IITA [2006-S-072-02, Controller SoC for Human body Communications].

### BACKGROUND ART

Human body communications is a technology using a fact that the human body is conductive. However, it is necessary to attach specific electrodes to human body communication devices. For example, when two persons shake hands, an electrode of a human body communication device of one person generates an electric field to transmit data to the other person through the wrist motions of the two persons. Such an electric field induces a micro current in a human body, thereby enabling data transmission through the human body. The amplitude of the micro current is about 1 nano ampere, which is smaller than the amplitude ff an electric current already flowing through the human body. Theoretically, a current of 1 nano ampere allows 400,000 bit data per second to be transmitted.

Therefore, it is necessary to provide a signal transmitting and receiving scheme to avoid a frequency band in which the noise power is concentrated and to achieve a higher processing gain by changing a data rate according to channel state in the human body communication system.

### DISCLOSURE OF INVENTION

### Technical Problem

The present invention provides a method of and apparatus for transmitting and receiving a signal through a human body to enable a data rate varied in a human body communication system adopting serial-to-parallel conversion and frequency selective spreading codes and circuit complexity for signal processing in a receiving side varied in a frequency band in which strength of a signal guided by a human body is greater than strength of a signal radiated outside the human body, other than frequency bands in which noise power is relatively more concentrated.

### Technical Solution

According to an aspect of the present invention, there is provided an apparatus for transmitting a signal, the apparatus comprising a header generator generating header information including a data rate; a data generator generating transmission data by repeating each data bit to be transmitted 0 to several times according to the data rate; a spreader spreading the transmission data using a spreading code in a desired frequency band; and a multiplexer multiplexing the header information and the spread data.

According to another aspect of the present invention, there is provided a method of transmitting a signal, the method comprising generating header information including a data rate; generating transmission data by repeating each data bit to be transmitted 0 to several times according to the data rate; spreading the transmission data using a spreading code in a desired frequency band; and multiplexing the header information and the spread data.

According to another aspect of the present invention, there is provided an apparatus for receiving a signal, the apparatus comprising a demultiplexer separating a header and data from received data; a header processor extracting header information including a data rate from the header; and a despreader spreading a plurality of input data differently according to the data rate, correlating the spread results with the received data, finding a largest correlation and determining an input data corresponding to the largest correlation as a despread data.

According to another aspect to the present invention, there is provided a method of receiving a signal, the method comprising separating a header and data from received data; extracting header information including a data rate from the header; spreading a plurality of input data varying according to the data rate; and correlating the spread results with the received data, finding a largest correlation and determining an input data corresponding to the largest correlation as a despread data.

### Advantageous Effects

According to the present invention, serial-parallel conversion and frequency selective spreading/despreading are adopted to transmit data at a variable data rate and obtain a high transmission gain using a data repetition characteristic according to the data rate. Consequently, interferences between human bodies and interferences caused by other electric devices can be reduced.

### DESCRIPTION OF DRAWINGS

The above and other features and advantages of the present invention will become more apparent by describing in detail exemplary embodiments thereof with reference to the attached drawings in which:

FIG. 1 illustrates a block diagram of a transmitter for human body communications according to an embodiment of the present invention;

FIG. 2 illustrates a frame configuration according to an embodiment of the present invention;

FIG. 3 illustrates examples of spreading codes according to an embodiment of the present invention;

FIG. 4 illustrates a circuit diagram of a frequency selective spreader according to an embodiment of the present invention;

FIG. 5 illustrates a block diagram of a receiver for human body communications according to an embodiment of the present invention;

FIG. 6 illustrates an exemplary structure of a frequency selective despreader of the receiver of FIG. 5 when a data rate index is 0, according to an embodiment of the present invention;

FIG. 7 illustrates an exemplary structure of the frequency selective despreader of the receiver of FIG. 5 when the data rate index is 1, according to an embodiment of the present invention;

FIG. 8 illustrates an exemplary structure of the frequency selective despreader of the receiver of FIG. 5 when the data rate index is 2, according to an embodiment of the present invention; and

FIG. 9 illustrates an exemplary structure of the frequency selective despreader of the receiver of FIG. 5 when the data rate index is 3, according to an embodiment of the present invention.

### MODE FOR INVENTION

The present invention will now be described more fully with reference to the accompanying drawings, in which exemplary embodiments of the invention are shown.

In the present invention, frequency selective baseband transmission technology is adopted to transmit data in a limited frequency band ranging from 5 MHz to 40 MHz and excluding frequency bands lower than 5 MHz and higher than 40 MHz, in which the human body noise power is relatively more concentrated than the other frequency bands.

The frequency selective baseband transmission technology indicates that a spreading code having the most dominant frequency characteristics in a desired frequency band is used to transmit data among the spreading codes used for a data processing gain. It is thereby advantageous that analog transmitting and receiving portions for the baseband transmission are simple, while a desired frequency band and processing gain can be obtained.

For example, when 64 Walsh codes are used as spreading codes, a frequency band ranging from 0 to 16 MHz is divided into 64 sub-bands and each Walsh code corresponds to each sub-band sequentially. Accordingly, the most dominant frequencies are equally distributed.

Then a frequency selective baseband transmission in a desired frequency band can be performed by dividing 64 Walsh codes into 4 subgroups and selecting a subgroup corresponding to the desired frequency band.

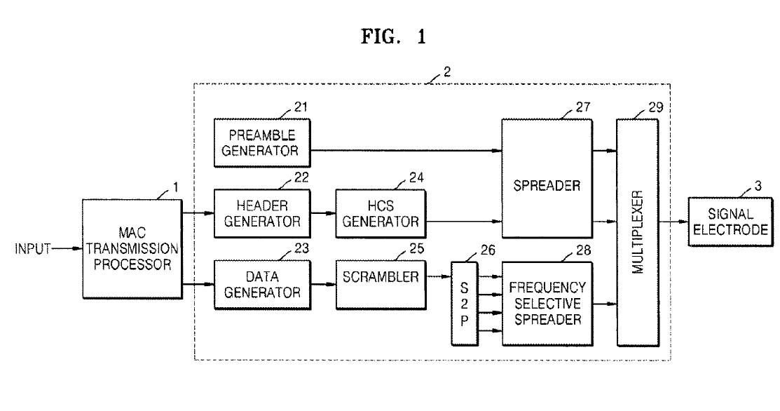

FIG. 1 illustrates a block diagram of a transmitter for human body communications according to an embodiment of the present invention.

The transmitter for human body communications includes a media access control (MAC) transmission processor 1 as a human body communication MAC hardware, a human body communication physical layer modulator 2, and a signal electrode 3.

The human body communication physical layer modulator 2 includes a preamble generator 21, a header generator 22, a data generator 23, a head check sequence (HCS) generator 24, a scrambler 25, a serial to parallel (P2S) converter 26, a spreader 27, a frequency selective spreader 28, and a multiplexer 29.

The signal electrode 3 is directly connected to a human body.

The MAC transmission processor 1 processes data to be transmitted and data information received from an upper layer and then outputs the processed data and data information to the human body communication physical layer modulator 2.

The preamble generator 21 generates a preamble set to initial values known to all users and of a predetermined length.

The header generator 22 receives the data information from the MAC transmission processor 1 including a data rate index, a modulation method, a user ID and a data length, and generates a header of a predefined format.

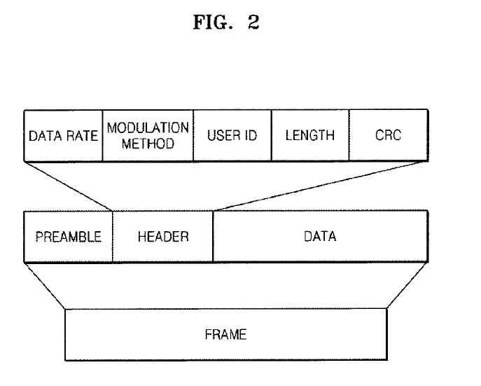

FIG. 2 illustrates a frame configuration according to an embodiment of the present invention.

Referring to FIG. 2, the frame includes a preamble, a header, and a data section. As explained above, the header includes a data rate field, a modulation method field, a user ID field, a data length field, and a cyclic redundancy check (CRC) value field.

Here, the data rate index is set for variable data transmission that determines the number of bit repetitions. Data rate indexes and the amounts of data corresponding to the data rate indexes are shown in Table 1 below.

[Table 1]

TABLE 1

| Data rate | | | Data | Bit |
|---|---|---|---|---|
| index | Data rate | | (Byte · Frame) | repetitions |
| 0 | 2 | Mbps | 2000 | 0 |
| 1 | 1 | Mbps | 1000 | 1 |
| 2 | 500 | Kbps | 500 | 3 |
| 3 | 250 | Kbps | 250 | 7 |

Referring to Table 1, when the data rate index is 0, the maximum data rate is 2 Mbps, data per frame is 2000 bytes, and data bits are transmitted without bit repetition. When the data rate index is 1, the maximum data rate is 1 Mbps, data per frame is 1000 bytes, and each data bit is transmitted twice with once bit repetition. When the data rate index is 2, the maximum data rate is 0.5 Mbps, data per frame is 5000 bytes, and each data bit is transmitted 4 times with 3 times bit repetitions. When the data rate index is 3, the maximum data rate is 0.25 Mbps, data per frame is 250 bytes, and each data bit is transmitted 8 times with 7 times bit repetitions.

Supporting of the variable data rate is to repeat each transmission data bit rather than to reduce transmission data rate in order to obtain a higher signal-to-noise ratio(SNR). Therefore, it is necessary to a frequency selective despreader of an efficient structure for a higher processing gain

The HCS generator 24 generates an HSC according to a header format received from the header generator 22.

The spreader 27 spreads data using predetermined spreading codes based on a preamble received from the preamble generator 21 and an HSC received from the HCS generator 24.

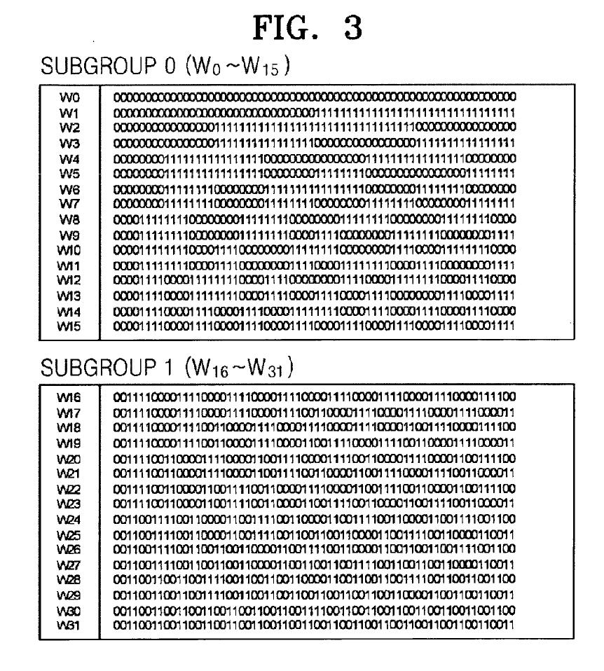

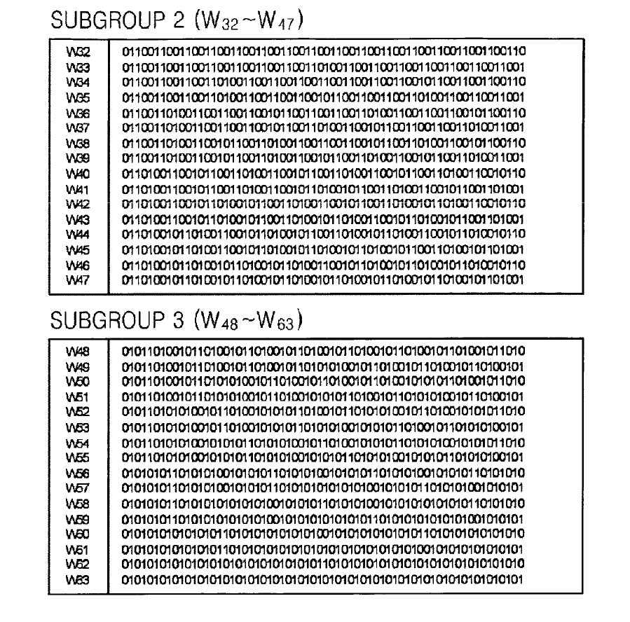

FIG. 3 illustrates sub groups of 64-bit Walsh codes as spreading codes according to an embodiment of the present invention. Referring to FIG. 3, 64 Walsh codes are used as the spreading codes. The 64 Walsh codes are divided into four sub groups, each of which has sixteen Walsh codes: a sub group 0 of W₀ to W₁₅, a sub group 1 of W₁₆ to W₃₁, a sub group 2 of W₃₂ to W₄₇, and a sub group 3 of W₄₈ to W₆₃. An available frequency band is exactly divided into 64 sub-bands and the most dominant frequency f_{d} is sequentially mapped to the 64 sub-bands.

The data generator 23 receives data from the MAC transmission processor 1 and outputs the data at a desired time. When outputting the data, the data generator 23 repeats each data bit according to the data rate index of variable data rate transmission.

The scrambler 25 is an optional element used for data security. The scrambler 25 is initialized using predefined initial values known to both transmitting and receiving sides and generates orthogonal codes. Data output from the data generator 23 are scrambled by an XOR operation with orthogonal codes generated by the scrambler 25. For the variable data rate transmission, a data rate of the scrambled codes output from the scrambler 25 is lowered according to the transmission data rate after the scrambling and data bit repetition.

The S2P converter 26 converts the scrambled data into a 4-bit parallel data set. The transmission frequency band can be reduced to ¼ owing to this serial-parallel conversion. That is, more data can be transmitted in the same frequency band, or greater spreading code gain can be obtained in the same frequency band, thereby allowing high-quality data transmission.

The frequency selective spreader 28 outputs frequency selective spreading codes for the 4-bit parallel data set output from the S2P converter 26. The multiplexer 29 outputs a preamble, a header, and data according to a predetermined frame format. The output of the multiplexer 29 is transmitted to a human body through the signal electrode 3.

The frequency selective spreader 28 enables baseband transmission in a desired frequency band and digital direct transmission whose output bit is 1 bit. Therefore, the output of the multiplexer 29 can be directly connected to the signal electrode 3 without using an additional analog processing unit such as a digital-analog converter and an intermediate frequency converter.

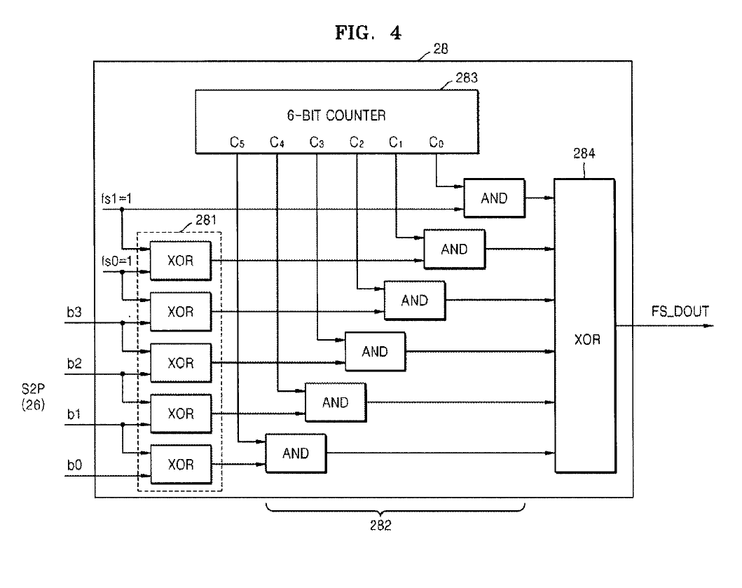

FIG. 4 illustrates an exemplary circuit diagram of the frequency selective spreader 28 according to an embodiment of the present invention.

Referring to FIG. 4, the frequency selective spreader 28 includes an XOR operation unit 281, an AND operation unit 282, a counter 283, and an XOR operator 284.

It is supposed that 64 Walsh codes can be used as spreading codes, and 16 Walsh codes of the subgroup 3, W₄₈ to W₆₃, are selected from the 64 Walsh codes. In this case, the counter 283 can be a 6-bit counter. The frequency selective spreader 28 also includes two frequency selection bits fs1 and fs0 for selecting the sub group 3 from the sub-groups of the 64 Walsh codes and lower four bits b3, b2, b1, and b0 for data input bits, and a 1-bit output, FS_DOUT.

Generally, when 2^{N} Walsh codes are used as spreading codes, and 2^{M} (M<N) Walsh codes are selected from the 2^{N} Walsh codes, the frequency selective spreader 28 uses uppermost (N−M) bits of total N input bits as frequency selection bits and sets frequency selection bit values to select a desired frequency band.

In this case, the frequency selective spreader 28 has an N-bit counter 283, and (N−M) frequency selection bits and M input data bits. The frequency selective spreader 28 also includes (N−1) XOR operators for gray indexing, an AND operation unit 282 for AND-operating outputs of the counter 283 with the uppermost frequency selection bit fs1 and outputs of the XOR operation unit 281, and an XOR operator 284 for XOR-operating outputs of the AND operation unit 282.

If 16 Walsh codes of the sub group 3, W₄₈ to W₆₃, shown in FIG. 3 are used, the frequency selective spreader 28 sets two frequency selection bits fs1 and fs0 to ‘11’.

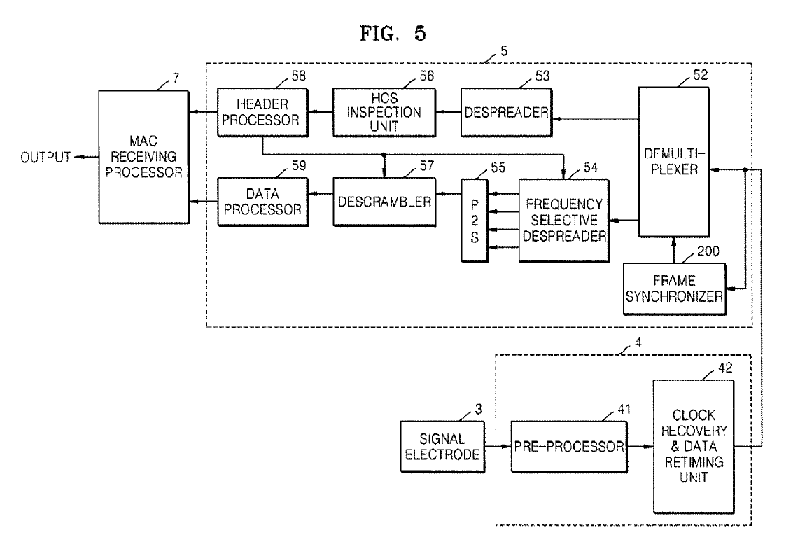

FIG. 5 illustrates a block diagram of a receiver for human body communications, according to an embodiment of the present invention;

Referring to FIG. 5, the receiver includes a human communication interface 4, a human communication physical layer demodulator 5, and a MAC receiving processor 7 as a MAC hardware.

The human communication interface 4 includes a pre-processor 41 and a clock recovery & data retiming unit 42. The pre-processor 41 receives a signal through a signal electrode 3, to which noise is added when the signal passes through a human body, filters out the noise and amplifies the signal to a desired level.

The clock recovery & data retiming unit 42 synchronizes the amplified signal with a clock of a receiving end and compensates a frequency offset.

The human communication physical layer demodulator 5 includes a frame synchronizer 200, a demultiplexer 52, a despreader 53, a frequency selective despreader 54, a parallel to serial (P2S) converter 55, an HCS inspection unit 56, a descrambler 57, a header processor 58, and a data processor 59.

The frame synchronizer 200 acquires frame synchronization from a received signal using a preamble. The demultiplexer 52 extracts a header section and a data section respectively from the signal using the frame synchronization.

The despreader 53 despreads the header section, and the HCS inspection unit 56 inspects an HCS of the despread header section to determine if errors occur. If errors occur, the header processor 58 stops the receiving process of current frame.

Otherwise, the header processor 58 extracts header information from the header section and outputs the extracted header information to the MAC receiving processor 7.

The frequency selective despreader 54 correlates the data section extracted by the demultiplexer 5l with 16 spreading codes used by the frequency selective spreader 28 of the transmitter so as to output a spreading code having the largest correlation as 4-bit data. The P2S converter 55 converts the 4-bit data into serial data.

The descrambler 57 performs descrambling the data output from the P2S converter 55 based on a data rate index included in the header information using an orthogonal code obtained from predefined initial values. The data processor 59 processes the descrambled data to acquire desired data.

The MAC receiving processor 7 combines the header information extracted by the header processor 58 and the data acquired by the data processor 59 to output the combined result to an upper layer.

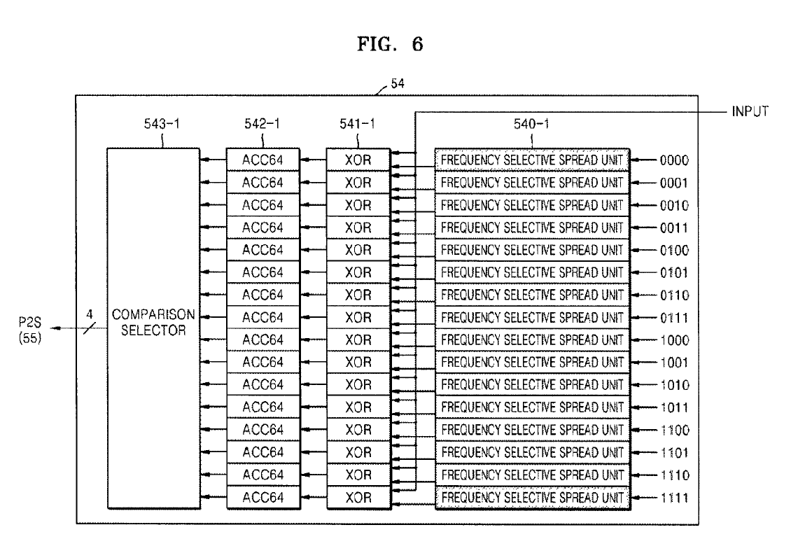

FIG. 6 illustrates an exemplary structure of the frequency selective despreader 54 when a data rate index is 0, according to an embodiment of the present invention. The frequency selective despreader 54 performs operations reversely to those performed by the frequency selective spreader 28 of FIG. 4. The data rate index is acquired from header information extracted from a header by the header processor 58.

The frequency selective despreader 54 includes a frequency selective spread unit 540-1, an XOR operation unit 541-1, an accumulation unit 542-1, and a comparison selector 543-1.

A signal INPUT input to the frequency selective despreader 54 is one of the 16 Walsh codes W₄₈ to W₆₃ to which noise is added when passing through a human body. Therefore, 0000, 0001, . . . , 1111 are input to the frequency selective spread unit 540-1 including 16 frequency selective spreaders to produce 16 Walsh codes. The 16 Walsh codes and the signal INPUT are input to 16 XOR operators of the XOR operation unit 541-1. Outputs of the 16 XOR operators of the XOR operation unit 541-1 are accumulated by 16 accumulators of the accumulation unit 542-1 during one Walsh code length, 64 bits, namely, one symbol period. 16 values output from the accumulation unit 542-1 are input to the comparison selector 543-1, and the comparison selector 543-1 selects one having the largest correlation with the input signal INPUT. That is, the comparison selector 543-1 selects the smallest value of the 16 values output from the accumulation unit 542-1. Then, the comparison selector 543-1 outputs 4-bit values which are input to the frequency selective spread unit 540-1 and have the accumulation unit 542-1 output the smallest value.

For example, when no noise is added to a signal when the signal passes through a human body in the transmitter and ‘0010’ is input to the frequency selective spreader 28, the frequency selective spreader 28 outputs W₅₀=(0101101001011010101001011010010110100101101001010101101001011010). When the W₅₀ is input to the frequency selective despreader 54, the accumulation unit 542-1 of the frequency selective despreader 54 outputs 32, 32, 0, 32, . . . , 32. The comparison selector 543-1 outputs ‘0010’ resulting ‘0’ as a despread value.

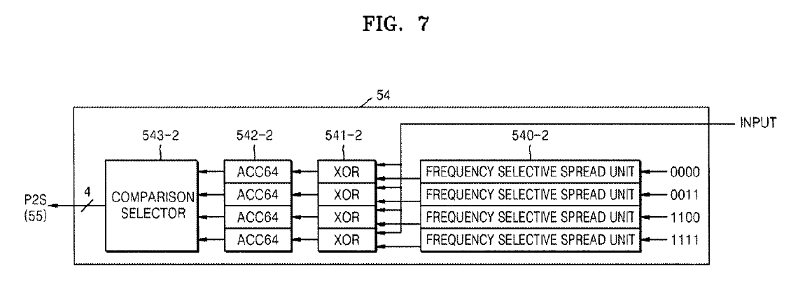

FIG. 7 illustrates an exemplary structure of the frequency selective despreader 54 when the data rate index is 1, according to an embodiment of the present invention. The data rate index of 1 is acquired from the header processor 58. In this case, each data bit is repeated once. Namely, the data are transmitted as 2 consecutive bit values are the same. Therefore, a frequency selective spread unit 540-2 receives 4 values: 0000, 0011, 1100, and 1111 and outputs 64-bit Walsh codes. An XOR operation unit 541-2 includes four XOR operators and XORs the received signal INPUT and outputs of the frequency selective spread unit 540-2. An accumulation unit 542-2 accumulates outputs of the XOR operation unit 541-2 for 64 bits. A comparison selector 543-2 compares four accumulated values output from the accumulation unit 542-2 to find the smallest value and selects a value input to the frequency selective spread unit 540-2 corresponding to the smallest value. The comparison selector 543-2 outputs the selected value as a despread value.

When the data rate index is 1, the frequency selective despreader 54 selects one of 0000, 0011, 1100, and 1111, not one of 16 values, due to the bit repetition characteristic. Therefore, the higher transmission gain can be achieved compared with the case of the data rate index 0.

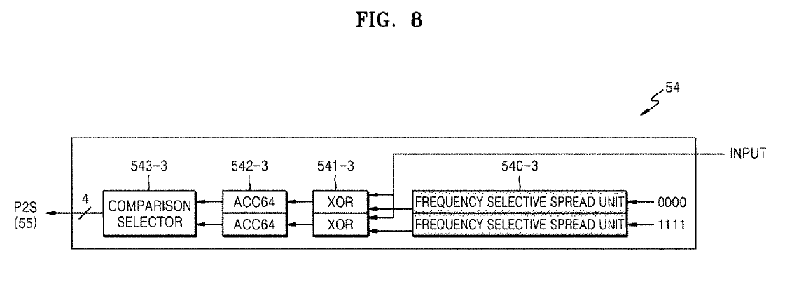

FIG. 8 illustrates exemplary structure of the frequency selective despreader 54 when the data rate index is 2, according to an embodiment of the present invention. When the data rate index is 2, four consecutive data bit values are the same due to 3 times repetition.

In this case, 0000 and 1111 are input to a frequency selective spread unit 540-3. An XOR operation unit 541-3 includes two XOR operators and XOR-operates the received signal INPUT with outputs of the frequency selective spread unit 540-3. An accumulation unit 542-3 accumulates outputs of the two XOR operators for 64 bits. A comparison selector 543-3 compares two accumulated values output from the accumulation unit 542-3 to find the smaller value and selects one value input to the frequency selective spread unit 540-3 corresponding to the smaller value. The comparison selector 543-3 outputs the selected value as a despread value. When the data rate index is 2, one of 4 consecutive bit values of 0000 and 1111 is output. Therefore, the higher transmission gain can be obtained as compared with the case of the data rate index 0 or 1.

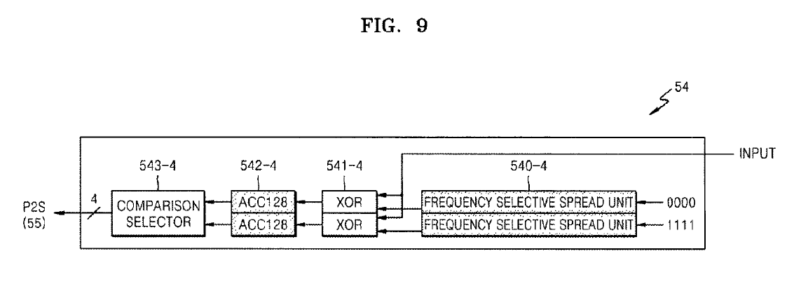

FIG. 9 illustrates an exemplary structure of the frequency selective despreader 54 when the data rate index is 3, according to an embodiment of the present invention.

When the data rate index is 3, each data bit is repeated 7 times. That is, eight consecutive bits have the same value and two successive symbols are the same.

The bit values 0000 and 1111 are input to a frequency selective spread unit 540-4. An XOR operation unit 541-4 includes two XOR operators and XOR-operates the received signal INPUT with outputs of the frequency selective spread unit 540-4. An accumulation unit 542-4 accumulates outputs of the two XOR operators for 128 bits. A comparison selector 543-4 compares two accumulated values output from the accumulation unit 542-4 to find the smaller value and selects one value input to the frequency selective spread unit 540-4 corresponding to the smaller value. The comparison selector 543-4 outputs the selected value as a despread value. When the data rate index is 3, two consecutive symbols have the same value. Therefore, a despread value can be selected by accumulating values of two symbols, and thus the higher transmission gain can be obtained as compared with the case of the data rate index 0, 1 or 2.

The exemplary structures of the frequency selective despreader 54 shown in FIGS. 6 through 9 are illustrated separately according to the data rate index for the sake of description. However, the frequency selective despreader 54 can be practically implemented into an integrated form whose power consumption and circuit size to be minimized, regardless of the data rate index.

While the present invention has been particularly shown and described with reference to exemplary embodiments thereof, it will be understood by those of ordinary skill in the art that various changes in form and details may be made therein without departing from the spirit and scope of the present invention as defined by the following claims .

1. An apparatus for transmitting a signal, comprising:
a header generator generating header information including a data rate;
a data generator generating transmission data by repeating each data bit to be transmitted 0 to several times according to the data rate;
a spreader spreading the transmission data using a spreading code in a desired frequency band; and
a multiplexer multiplexing the header information and the spread data.

2. The apparatus of claim 1, wherein the spreader spreads the transmission data after converting the transmission data into parallel data.

3. The apparatus of claim 2, wherein the spreader spreads the transmission data by using 2^{N} Walsh codes as the spreading code, selecting 2^{M} (M<N) Walsh codes, replacing uppermost bits among N input bits with (N−M) frequency selection bits, and setting frequency selection bit values to select a desired frequency band.

4. A method of transmitting a signal, comprising:
generating header information including a data rate;
generating transmission data by repeating each data bit to be transmitted 0 to several times according to the data rate;
spreading the transmission data using a spreading code in a desired frequency band; and
multiplexing the header information and the spread data.

5. The method of claim 4, further comprising converting the transmission data into parallel data before the spreading of the transmission data.

6. The method of claim 5, wherein the spreading of the transmission data comprises:
using 2^{N} Walsh codes as the spreading code;
selecting 2^{M} (M<N) Walsh codes;
replacing uppermost bits of N input bits with (N−M) frequency selection bits; and
setting frequency selection bit values to select a desired frequency band.

7. An apparatus for receiving a signal, comprising:
a demultiplexer separating a header and data from received data;
a header processor extracting header information including a data rate from the header; and
a despreader spreading a plurality of input data differently according to the data rate, correlating the spread results with the received data, finding a largest correlation and determining an input data corresponding to the largest correlation as a despread data.

8. The apparatus of claim 7, wherein the despreader comprises:
a spread unit spreading the plurality of the input data using a spreading code in a desired frequency band;
a correlation unit correlating outputs of the spread unit and the received data; and
a comparison selector comparing correlation results output from the correlation unit so as to output the input data corresponding to the largest correlation as the despread data.

9. The apparatus of claim 8, wherein the spread unit spreads the plurality of the input data by using 2^{N} Walsh codes as the spreading code, selecting 2^{M} (M<N) Walsh codes, replacing (N−M) frequency selection bits with uppermost bits of N input bits when M is equal to a number of bits of the input data, and setting frequency selection bit values to select a desired frequency band.

10. The apparatus of claim 8, wherein the correlation unit comprises:
an XOR operation unit XORing the outputs of the spread unit with the received data, respectively; and
an accumulation unit accumulating outputs of the XOR operation unit for a symbol period corresponding to the data rate.

11. A method of receiving a signal, comprising:
separating a header and data from received data;
extracting header information including a data rate from the header;
spreading a plurality of input data varying according to the data rate; and
correlating the spread results with the received data, finding a largest correlation and determining an input data corresponding to the largest correlation as a despread data.

12. The method of claim 11, wherein the spreading of the pieces of input data comprises:
using 2^{N} Walsh codes as the spreading code;
selecting 2^{M} (M<N) Walsh codes;
replacing (N<M) frequency selection bits with uppermost bits of N input bits when M is equal to a number of bits of the input data; and
setting frequency selection bit values to select a desired frequency band.

13. The method of claim 11, wherein the correlating the spread results with the received data comprises:
XORing the spread results with the received data, respectively; and
accumulating the XORed results for a symbol period corresponding to the data rate.
